(19) United States
(12) Patent Application Publication
(10) Pub. No.: US 2026/0000972 A1
(43) Pub. Date: Jan. 1, 2026

(54) GAME CONTROL DEVICE AND BUTTON MODULE THEREOF

(71) Applicant: Chicony Electronics Co., Ltd., New Taipei City (TW)

(72) Inventors: Jung-Hsiu Lee, New Taipei City (TW); Ting-Sheng Wang, New Taipei City (TW)

(21) Appl. No.: 19/189,683

(22) Filed: Apr. 25, 2025

(30) Foreign Application Priority Data
Jul. 1, 2024 (TW) 113207053

(51) Int. Cl. A63F 13/24

(52) U.S. Cl. CPC A63F 13/24

(57) ABSTRACT

A game control device and a button module of the game control device are provided. The button module includes a hollow base, a hollow adjustment member, and a button. The hollow base has a top portion and a bottom portion. The hollow adjustment member is rotatably disposed on the top portion of the hollow base, and the hollow adjustment member has a top surface. The button is disposed in the hollow adjustment member, and the button has a top end and a bottom end. The top end protrudes from the top surface of the hollow adjustment member, and the bottom end is connected to a switch triggering member.

### CROSS-REFERENCE TO RELATED APPLICATION

This non-provisional application claims priority under 35 U.S.C. § 119(a) to patent application No. 113207053 filed in Taiwan, R.O.C. on Jul. 1, 2024, the entire contents of which are hereby incorporated by reference.

### BACKGROUND

### Technical Field

The instant disclosure relates to a control device, in particular, to a game control device and a button module thereof.

### Related Art

The game control device is a device for a user for inputting signals into a game upon playing the game. For example, the user may control the character and perform various motions in the game through the button(s) provided on the game control device.

### SUMMARY

In general, the button of a game control device known to the inventor provides fixed pressing stroke and fixed operation feeling. As a result, when the user wants to have different pressing strokes or operation feelings due to different games or personal preferences, the user needs to replace the game control device or the button of the game control device with another one, which thus causes inconvenience and burden for the user.

In view of this, in one embodiment, a button module of a game control device is provided. The button module comprises a hollow base, a hollow adjustment member, and a button. The hollow base has a top portion and a bottom portion. The hollow adjustment member is rotatably disposed on the top portion of the hollow base, and the hollow adjustment member has a top surface. The button is disposed in the hollow adjustment member, and the button has a top end and a bottom end. The top end protrudes from the top surface of the hollow adjustment member, and the bottom end is connected to a switch triggering member. The hollow adjustment member is selectively rotated with respect to the hollow base to drive the button to be moved to a first height position or a second height position. When the button is at the first height position, a first spacing is between the switch triggering member and the bottom portion of the hollow base, when the button is at the second height position, a second spacing is between the switch triggering member and the bottom portion of the hollow base, and the second spacing is different from the first spacing.

In another embodiment, a game control device is provided. The game control device comprises a housing, a circuit board, and the button module mentioned above. The housing comprises a cover plate, and the cover plate has an outer surface and a through hole. The circuit board is disposed in the housing and has a switch. The button module is disposed in the housing and corresponds to the through hole. The top end of the button of the button module protrudes from the outer surface of the cover plate, and a position of the switch triggering member corresponds to a position of the switch.

Based on the above, in the button module of the game control device according to one or some embodiments of the instant disclosure, the user can freely adjust the height positions of the button and the switch triggering member by rotating the hollow adjustment member, thereby allowing the button to provide different operation feelings to meet game requirements or to satisfy personal preferences for the user. Therefore, the user does not need to replace the game control device or the button of the game control device with another one having a different operation feeling, thereby providing a better convenience of use and reducing cost of usage.

### BRIEF DESCRIPTION OF THE DRAWINGS

The disclosure will become more fully understood from the detailed description given herein below for illustration only, and thus not limitative of the disclosure, wherein:

FIG. 1 illustrates a perspective view of a game control device according to an exemplary embodiment of the instant disclosure;

FIG. 2 illustrates an exploded view of the game control device of the exemplary embodiment;

FIG. 3 illustrates a partial perspective view of the game control device of the exemplary embodiment;

FIG. 4 illustrates an exploded view of a button module according to a first embodiment of the instant disclosure;

FIG. 5 illustrates a cross-sectional view of the button module of the first embodiment, where the button of the button module is at the first height position;

FIG. 6 illustrates a cross-sectional view of the button module of the first embodiment, where the button of the button module is at the second height position;

FIG. 7 illustrates a top view of the button module of the first embodiment;

FIG. 8 illustrates an exploded view of a button module according to a second embodiment of the instant disclosure;

FIG. 9 illustrates a side view of the button module of the second embodiment, where the button of the button module is at the first height position;

FIG. 10 illustrates a cross-sectional view along the line 10-10 shown in FIG. 9;

FIG. 11 illustrates a side view of the button module of the second embodiment, where the button of the button module is at the second height position;

FIG. 12 illustrates a cross-sectional view of a button module according to a third embodiment of the instant disclosure;

FIG. 13 illustrates a cross-sectional view of a button module according to a fourth embodiment of the instant disclosure; and

FIG. 14 illustrates a cross-sectional view of a button module according to a fifth embodiment of the instant disclosure.

### DETAILED DESCRIPTION

It should be noted that, in the descriptions for the embodiments, the ordinal numbers, e.g., “first,” “second,” “third,” and “fourth” are respectively used to describe different elements, and these elements are not limited due to the use of these ordinal numbers. Furthermore, for the sake of convenience and clarity, the thickness or size of each component in the drawings is exaggerated, omitted, or schematically expressed for the purpose of understanding and reading by persons having ordinary skills in the art, and the size of each component is not the actual size of the component and is not intended to limit the conditions under which the instant disclosure can be implemented, and thus the size of the component does not have substantive technical meaning. Moreover, it is understood that, any structural modifications, changes in proportions, or adjustments in size should still fall within the scope of the technical content disclosed in the instant disclosure without affecting the effects that can be produced and the purposes that can be achieved by the instant disclosure. Moreover, in all the drawings, the same reference numbers are used to indicate identical or similar elements.

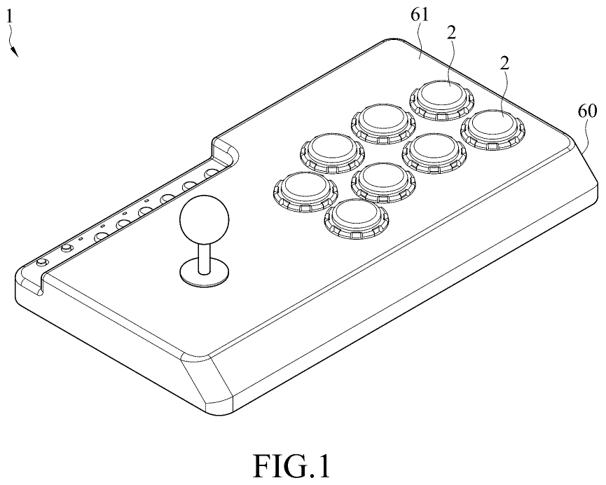

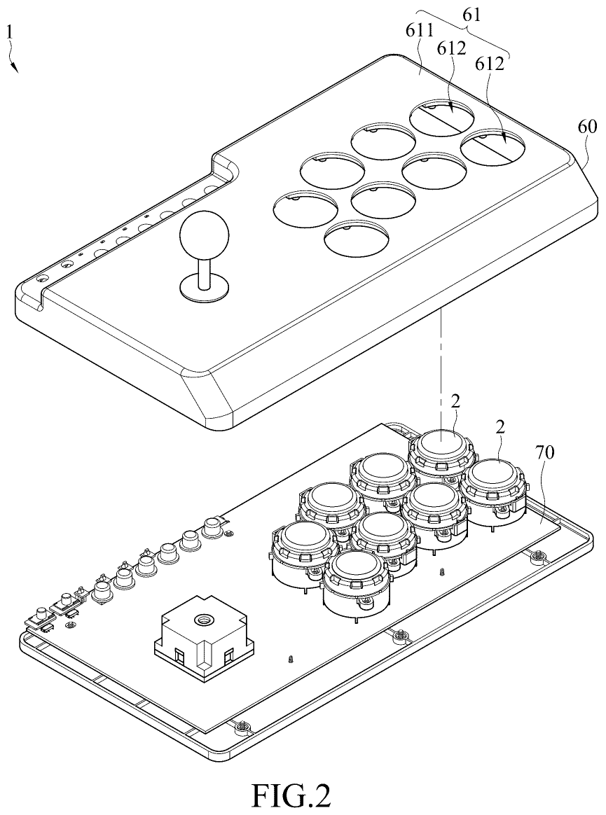

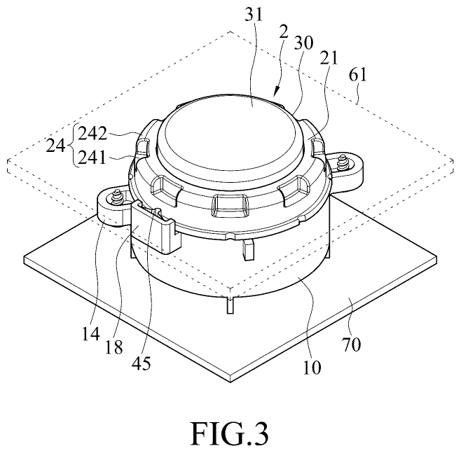

FIG. 1 illustrates a perspective view of a game control device according to an exemplary embodiment of the instant disclosure. FIG. 2 illustrates an exploded view of the game control device of the exemplary embodiment. FIG. 3 illustrates a partial perspective view of the game control device of the exemplary embodiment. As shown in FIG. 1 to FIG. 3, according to one or some embodiments of the instant disclosure, the game control device 1 comprises at least one button module 2, a housing 60, and a circuit board 70. In some embodiments, the game control device 1 may be a game controller for various electronic apparatuses upon executing the games. For example, the electronic apparatus may be a home game console, a handheld game console, a computer, a smart phone, or the like. Moreover, the game control device 1 may be a wired game controller or a wireless game controller.

As shown in FIG. 1 to FIG. 3, the housing 60 comprises a cover plate 61. The cover plate 61 has an outer surface 611 and at least one through hole 612, and the through hole 612 is in communication with the internal accommodation space of the housing 60. In this embodiment, the through hole 612 is a round hole, but may be a hole with other shapes (such as elliptical, square, rectangular, or irregular). Moreover, the number and the position of the through hole 612 corresponds to the number and the position of the button module 2, and the through hole 612 is provided for being assembling with the button module 2. For example, in this embodiment, both the number of the through holes 612 and the number of the button modules 2 are eight (as shown in FIG. 2), but the instant disclosure is not limited thereto; the number of the through holes 612 and the number of the button modules 2 may be one or more, depending on actual product demands. In some other embodiments, the number of the through holes 612 does not correspond to the number of the button modules 2; for example, one through hole 612 may correspond to two button modules 2.

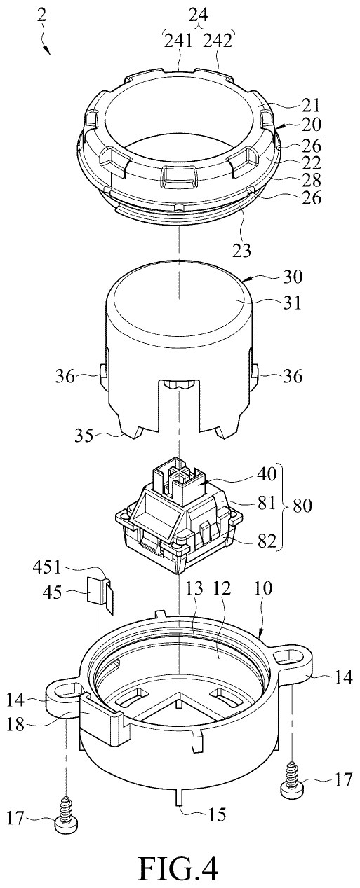

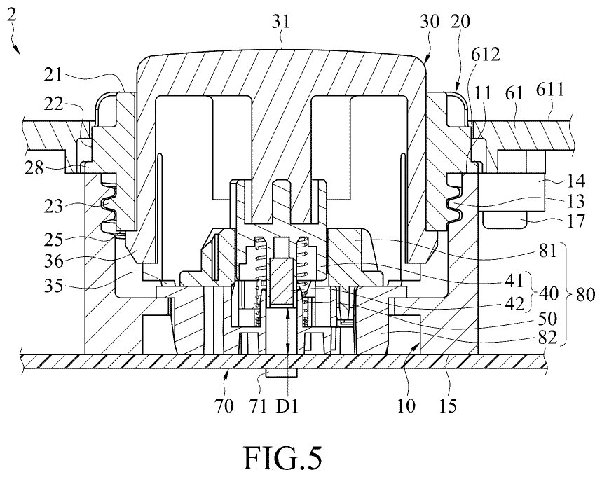

FIG. 4 illustrates an exploded view of a button module according to a first embodiment of the instant disclosure. FIG. 5 illustrates a cross-sectional view of the button module of the first embodiment, where the button of the button module is at the first height position. As shown in FIG. 2, FIG. 4, and FIG. 5, the circuit board 70 is disposed in the housing 60 and has at least one switch 71, and the number and the position of the switch 71 also correspond to the number and the position of the button module 2. In some embodiments, the switch 71 may be a mechanical switch, an electrical switch, or a sensor switch (e.g., a magnetic sensor switch, an optical sensor switch, a capacitive sensor switch, or the like).

As shown in FIG. 1 to FIG. 5, the button modules 2 are disposed in the housing 60 and between the cover plate 61 and the circuit board 70. Each of the button modules 2 corresponds to a corresponding one of the through holes 612 and comprises a hollow base 10, a hollow adjustment member 20, a button 30, and an elastic member 50. The hollow base 10 has a top end 11 and a bottom end 15, and the button module 2 is assembled on the housing 60 through the hollow base 10. In this embodiment, the hollow base 10 has two assembling portions 14; for example, in this embodiment, the two assembling portions 14 are two lugs at two opposite sides of the hollow base 10, and the two assembling portions 14 are assembled on the cover plate 61 of the housing 60 with two locking members 17, but the instant disclosure is not limited thereto. In some other embodiments, the button module 2 may be assembled on the housing 60 through other components. Alternatively, in some other embodiments, the button module 2 may be assembled on other components (such as the circuit board 70) instead assembling on the housing 60.

As shown in FIG. 3 to FIG. 5, the hollow adjustment member 20 of the button module 2 is rotatably disposed on the top portion 11 of the hollow base 10; in other words, when the hollow adjustment member 20 is operated, the hollow adjustment member 20 is rotatable with respect to the hollow base 10. The hollow adjustment member 20 has a top surface 21, an outer annular surface 22, and a bottom surface 25, and the outer annular surface 22 is connected between the top surface 21 and the bottom surface 25. The top surface 21 of the hollow adjustment member 20 passes through the through hole 612 and protrudes from the outer surface 611 of the cover plate 61, and the bottom surface 25 of the hollow adjustment member 20 is in the hollow base 10. Therefore, the user can control the hollow adjustment member 20 externally from the game control device 1.

As shown in FIG. 2 to FIG. 5, in this embodiment, the hollow adjustment member 20 is disk-shaped to correspond to the shape of the through hole 612. In some embodiments, the portion of the hollow adjustment member 20 protruding from the outer surface 611 of the cover plate 61 (such as the top surface 21) may have other shapes (such as square, elliptical, rectangular), depending on the demands for the actual product appearance. Moreover, in the case that the shape of the portion of the hollow adjustment member 20 protruding from the outer surface 611 is not round, the force application of the user for operating the hollow adjustment member 20 to be rotated can be facilitated. However, the above embodiments are provided for illustrative purposes; in some other embodiments, the top surface 21 of the hollow adjustment member 20 and the outer surface 611 of the cover plate 61 may be arranged at the same height, or the top surface 21 of the hollow adjustment member 20 may be lower than the outer surface 611 of the cover plate 61 (for example, the top surface 21 is within the through hole 612).

As shown in FIG. 3 to FIG. 5, the button 30 is disposed in the hollow adjustment member 20. The button 30 has a top end 31 and a bottom end 35, and the top end 31 protrudes from the top surface 21 of the hollow adjustment member 20 and the outer surface 611 of the cover plate 61. Therefore, the user can press the button 30 externally from the game control device 1.

As shown in FIG. 3 to FIG. 5, the elastic member 40 is disposed in the hollow base 10 and elastically abuts against the button 30 directly or indirectly, for example, the elastic member 50 may be a spring (as shown in FIG. 5), an elastomer (such as an elastic rubber), an elastic piece, or the like. The bottom end 35 of the button 30 is connected to a switch triggering member 40, and the position of the switch triggering member 40 corresponds to the position of the switch 71. Therefore, when the button 30 is pressed to be moved toward the circuit board 70, the button 30 compresses the elastic member 50 to store an elastic force in the elastic member 50 and allows the switch triggering member 40 to trigger the switch 71 to generate corresponding control signal(s). When the button 30 is released, the elastic force stored in the elastic member 50 allows the button 30 to be moved away from the circuit board 70 and back to the unpressed position.

As shown in FIG. 4 and FIG. 5, in this embodiment, a switch module 80 is in the hollow base 10, and the switch module 80 comprises an upper shell 81, a lower shell 82, and the switch triggering member 40 and the elastic member 50 mentioned above. The upper shell 81 and the lower shell 82 are assembled with each other, and the internal space of the upper shell 81 and the internal space of the lower shell 82 are in communication with each other. The switch triggering member 40 and the elastic member 50 are disposed in the upper shell 81 and the lower shell 82, one of two ends of the elastic member 50 is assembled with the lower shell 82, and the other end of the elastic member 50 abuts against the switch triggering member 40 and indirectly abuts against the button 30.

As shown in FIG. 5, in this embodiment, the switch 71 is a magnetic sensor switch. The switch triggering member 40 comprises a connection member 41 and a magnetic member 42. The connection member 41 is assembled with the button 30, the magnetic member 42 is disposed on one end of the connection member 41 adjacent to the switch 71, and the magnetic member 42 of the switch triggering member 40 is spaced apart from the switch 71. When the button 30 is pressed to be moved toward the circuit board 70, the magnetic member 42 and the switch 71 can have mutual response to allow the switch 71 to be triggered to generate corresponding signal(s).

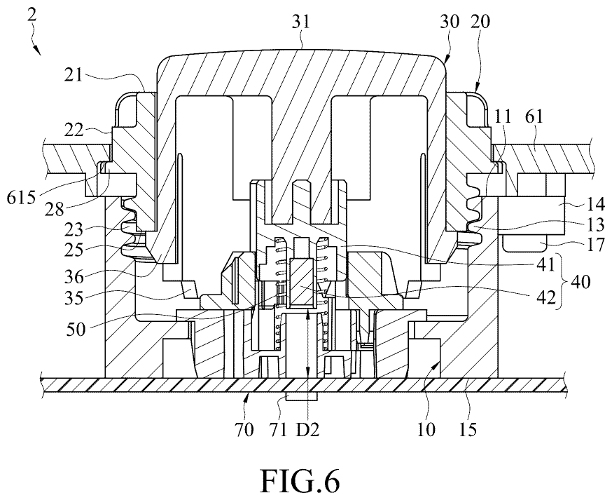

FIG. 6 illustrates a cross-sectional view of the button module of the first embodiment, where the button of the button module is at the second height position. As shown in FIG. 5 and FIG. 6, the button 30 is assembled with the hollow adjustment member 20. Moreover, when the user operates the hollow adjustment member 20 to be rotated with respect to the hollow base 10, the rotation of the hollow adjustment member 20 drives the button 30 and the switch triggering member 40 to be moved to different height positions, thereby generating different operation feelings to meet game requirements or to satisfy personal preferences for the user. Therefore, the user does not need to replace the game control device or the button of the game control device with another one having a different operation feeling, thereby providing a better convenience of use and reducing cost of usage. Details are described along with accompanied drawings.

As shown in FIG. 4 and FIG. 5, in this embodiment, a portion of the button 30 adjacent to the bottom end 35 has at least one hook portion 36 (in this embodiment, the number of the hook portions 36 is two, but the instant disclosure is not limited thereto). The two hook portions 36 are hooked at the bottom surface 25 of the hollow adjustment member 20 and the elastic member 50 elastically abuts against the button 30, so that the button 30 and the hollow adjustment member 20 can be assembled with each other. Moreover, the hollow base 10 has an inner annular surface 12, and the inner annular surface 12 has a first thread portion 13. The hollow adjustment member 20 has the outer annular surface 22, the outer annular surface 22 has a second thread portion 23, and the second thread portion 23 is threaded with the first thread portion 13. Therefore, the hollow adjustment member 20 can be rotated with respect to the hollow base 10 through the first thread portion 13 and the second thread portion 23, so that the height position of the hollow adjustment member 20 with respect to the bottom portion 15 of the hollow base 10 can be changed. Moreover, the rotation of the hollow adjustment member 20 drives the button 30 to be moved correspondingly, so that the height position of the button 30 with respect to the bottom portion 15 of the hollow base 10 can be changed.

For example, as shown in FIG. 5 and FIG. 6, the hollow adjustment member 20 can be operated by the user so as to be rotated with respect to the hollow base 10, so that the rotation of the hollow adjustment member 20 drives the button 30 to be moved to a first height position (the position of the button 30 shown in FIG. 5) or a second height position (the position of the button 30 shown in FIG. 6). As shown in FIG. 5, when the button 30 is at the first height position, a first spacing D1 is between the switch triggering member 40 and the bottom portion 15 of the hollow base 10. As shown in FIG. 6, when the button 30 is at the second height position, a second spacing D2 is between the switch triggering member 40 and the bottom portion 15 of the hollow base 10, and the second spacing D2 is different from the first spacing D1 (in this embodiment, the second spacing D2 is greater than the first spacing D1). Accordingly, depending on that the button 30 is at the first height position or the second height position, the elastic member 50 can have different compression extents, and different distances can be provided between the switch triggering member 40 and the switch 71 to allow the button 30 to have different pressing strokes, thereby allowing the user to have different operation feelings upon pressing the button 30 at different height positions.

As shown in FIG. 3 and FIG. 4, the top surface 21 of the hollow adjustment member 20 may have a skidproof structure 24. For example, the skidproof structure 24 may be a recessed structure (such as a recessed groove or a recessed pattern) or a protruding structure (such as a protruding block, a protruding spot, or a protruding pattern), so that the user can operate the hollow adjustment member 20 conveniently. In this embodiment, the skidproof structure 24 comprises a plurality of concave portions 241 and a plurality of convex portions 242, and the concave portions 241 and the convex portions 242 are alternately and annularly arranged on the top surface 21 of the hollow adjustment member 20. Therefore, when the user operates the hollow adjustment member 20 to be rotated, the skidproof structure 24 increases the friction force at the contact area between the user and the hollow adjustment member 20, so that the user can operate the hollow adjustment member 20 with less force. In some embodiments, the skidproof structure 24 may merely comprise the concave portion 241 or may merely comprise the convex portion 242, and the number of the concave portion 241 or the number of the convex portion 242 is not limited.

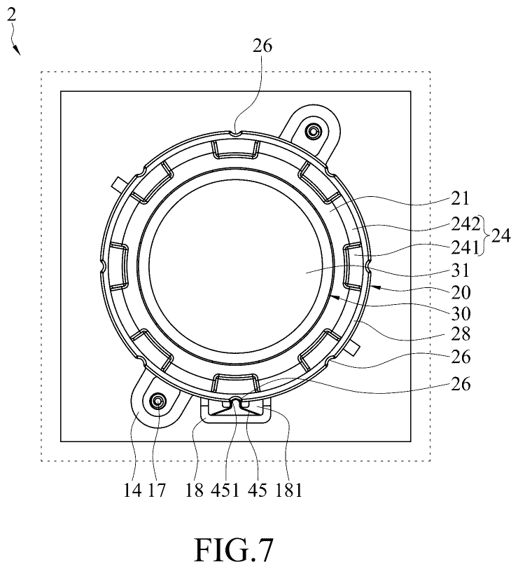

FIG. 7 illustrates a top view of the button module of the first embodiment. As shown in FIG. 4 and FIG. 7, the outer annular surface 22 of the hollow adjustment member 20 has a plurality of limiting grooves 26, and the limiting grooves 26 are arranged annularly and spaced apart from each other. The hollow base 10 is provided with an elastic piece 45, and the elastic piece 45 has a limiting protrusion 451. In this embodiment, one side of the hollow base 10 has a fixation base 18, the elastic piece 45 is V-shaped and disposed in a receiving groove 181 of the fixation base 18, but the instant disclosure is not limited thereto. In some other embodiments, the elastic piece 45 may be of other shapes (such as C-shape, D-shape, or other irregular shapes).

Further, as shown in FIG. 7, when the hollow adjustment member 20 is rotated to allow the button 30 to be at different height positions, the limiting protrusion 451 of the elastic piece 45 can be limited within one of the limiting grooves 26, so that the movement of the hollow adjustment member 20 can be limited. For example, when the button 30 is at the first height position (as shown in FIG. 5), the limiting protrusion 451 can be limited within one of the limiting grooves 26; when the button 30 is at the second height position (as shown in FIG. 6), the limiting protrusion 451 can be limited with another one of the limiting grooves 26, thereby allowing the hollow adjustment member 20 to have different adjustment stages.

Refer to FIG. 4 to FIG. 7. The outer annular surface 22 of the hollow adjustment member 20 is provided with a limiting flange 28 to prevent the hollow adjustment member 20 from detaching off the cover plate 61 of the housing 60 during operation. In this embodiment, the limiting flange 28 is ring-shaped and integrally connected to the outer annular surface 22, and the limiting grooves 26 are arranged on the limiting flange 28. As shown in FIG. 6, when the hollow adjustment member 20 is operated by the user to be rotated and moved away from the circuit board 70, the limiting flange 28 abuts against the inner surface 615 of the cover plate 61 to prevent the detachment of the hollow adjustment member 20.

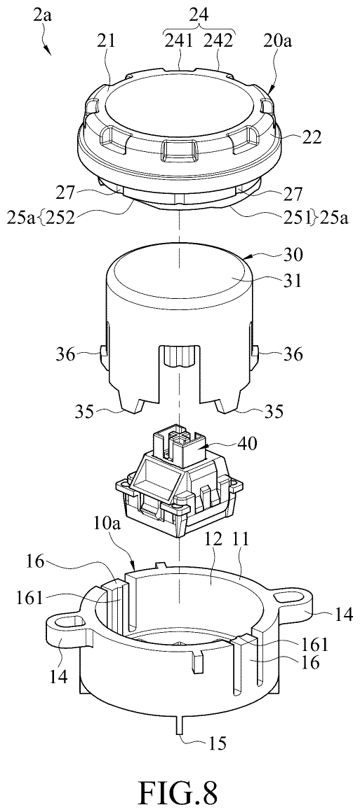

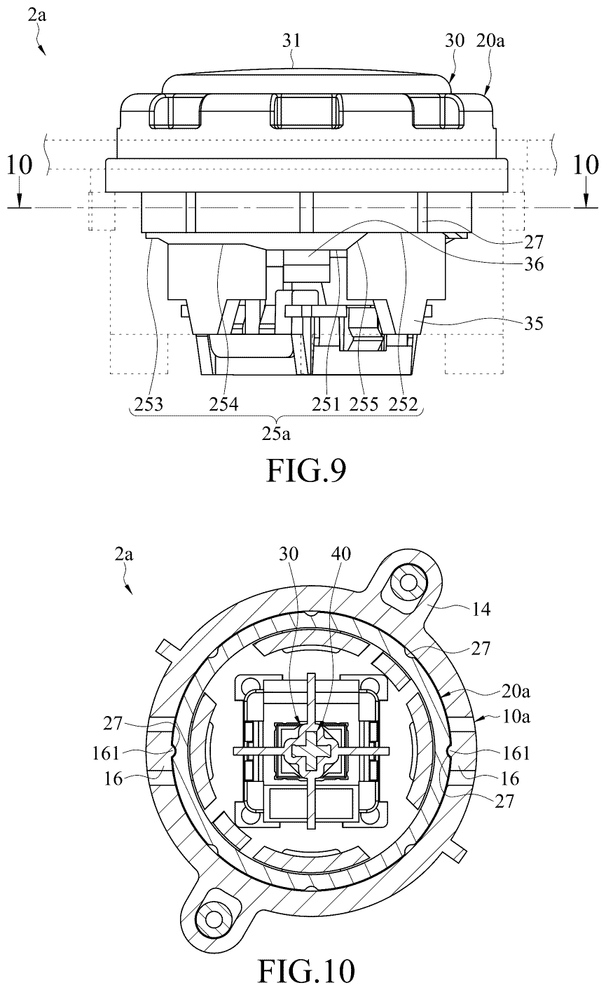

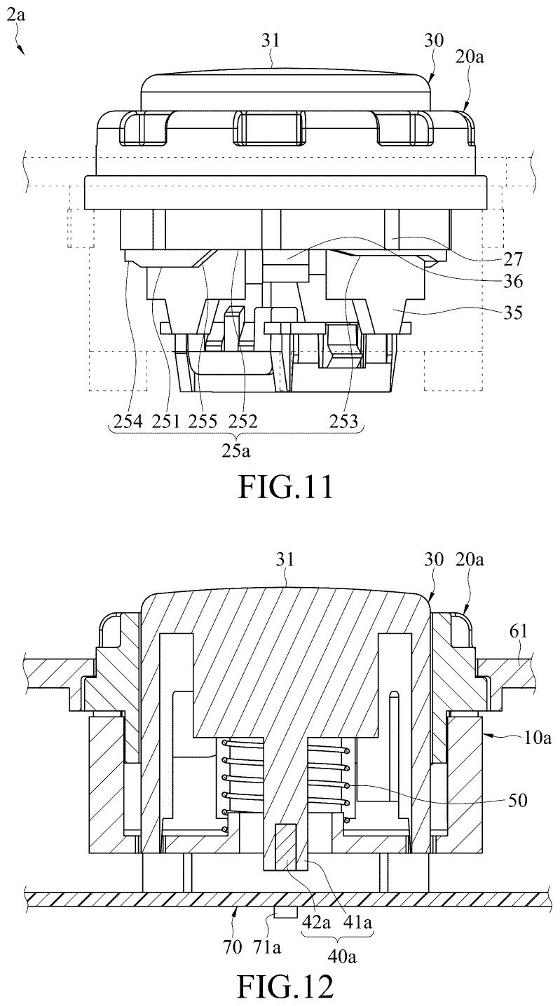

FIG. 8 illustrates an exploded view of a button module according to a second embodiment of the instant disclosure. FIG. 9 illustrates a side view of the button module of the second embodiment, where the button of the button module is at the first height position. FIG. 10 illustrates a cross-sectional view along the line 10-10 shown in FIG. 9. FIG. 11 illustrates a side view of the button module of the second embodiment, where the button of the button module is at the second height position. As shown in FIG. 8 to FIG. 11, the difference between this embodiment and the first embodiment at least lies in that, in this embodiment, the hollow adjustment member 20a and the hollow base 10a of the button module 2a are not assembled with each other by threading; in this embodiment, the hollow adjustment member 20a is placed on the hollow base 10a, so that the hollow adjustment member 20a can be rotated with respect to the hollow base 10a while the height position of the hollow adjustment member 20a with respect to the hollow base 10a is not changed.

Furthermore, as shown in FIG. 8 to FIG. 11, in this embodiment, the bottom surface 25a of the hollow adjustment base 20a has at least two supporting surfaces (in this embodiment, the bottom surface 25a has a first supporting surface 251, a second supporting surface 252, a third supporting surface 253, and a fourth supporting surface 254). The supporting surfaces are at different heights with respect to the bottom portion 15 of the hollow base 10 to form a stepped surface, and a guiding bevel is between two adjacent supporting surfaces. For example, take the first supporting surface 251 and the second supporting surface 252 as an example, the first supporting surface 251 and the second supporting surface 252 are at different heights, and a guiding bevel 255 is connected between the first supporting surface 251 and the second supporting surface 252 (as shown in FIG. 9).

As shown in FIG. 9 and FIG. 11, when the hollow adjustment member 20a is rotated, the hook portion 36 of the button 30 can be hooked at the supporting surfaces with different heights to allow the button 30 to be moved to different height positions. For example, as shown in FIG. 9, when the button 30 is at a first height position, the hook portion 36 of the button 30 can be hooked at the first supporting surface 251. When the hollow adjustment member 20a is operated by the user to be rotated with respect to the hollow base 10a, during the rotation of the hollow adjustment member 20a, the hook portion 36 of the button 30 can be guided by the guiding bevel 255 so as to be hooked at the second supporting surface 252 and moved to a second height position. Accordingly, the user can also freely adjust the height positions of the button 30 by rotating the hollow adjustment member 20a, so that when the user presses the button 30, the button 30 can provide different operation feelings to meet game requirements or to satisfy personal preferences.

As shown in FIG. 8 and FIG. 10, in this embodiment, the outer annular surface 22 of the hollow adjustment member 20a has a plurality of grooves 27, and the grooves 27 are arranged annularly and spaced apart from each other. The hollow base 10a has at least one flexible arm 16 (in this embodiment, the number of the flexible arms 16 is two, but the instant disclosure is not limited thereto). The flexible arm 16 may be formed by hollowing portions of the side wall of the hollow adjustment member 20a, and the flexible arm 16 has a protrusion 161. When the hollow adjustment member 20a is rotated to allow the button 30 to be at different height positions, the protrusion 161 of the flexible arm 16 can be limited within one of the grooves 27, so that the movement of the hollow adjustment member 20a can be limited. For example, when the button 30 is at the first height position (as shown in FIG. 9), the protrusion 161 is limited within one of the grooves 27; when the button 30 is at the second height position (as shown in FIG. 11), the protrusion 161 is limited within another one of the grooves 27. Therefore, the hollow adjustment member 20a can provide various adjustment stages for the user.

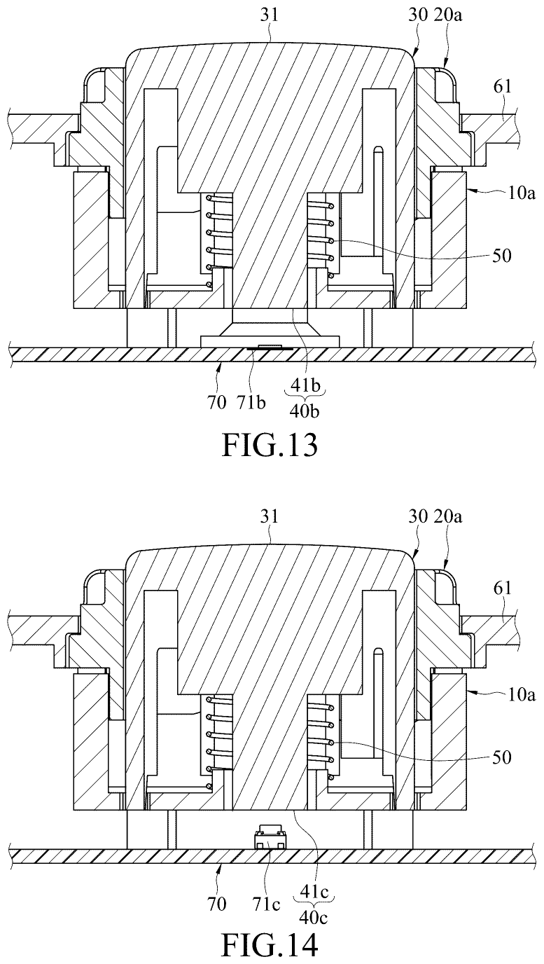

FIG. 12 illustrates a cross-sectional view of a button module according to a third embodiment of the instant disclosure. FIG. 13 illustrates a cross-sectional view of a button module according to a fourth embodiment of the instant disclosure. FIG. 14 illustrates a cross-sectional view of a button module according to a fifth embodiment of the instant disclosure. In some embodiments, the switch triggering member 40 and the switch 71 may have various combinations. For example, as shown in FIG. 12, in this embodiment, the switch triggering member 40a also comprises a connection member 41a and a magnetic member 42a, and the switch 71a is a magnetic sensor switch to correspond to the magnetic member 42a. The difference between this embodiment and the first embodiment/the second embodiment lies in that, in this embodiment, the connection member 41a of the switch triggering member 40a and the button 30 are integrally formed as a one-piece structure, rather than an assembled structure.

Alternatively, as shown in FIG. 13, the difference between this embodiment and the first embodiment/the second embodiments lies in that, in this embodiment, the switch triggering member 40b only comprises a connection member 41b, the connection member 41b and the button 30 are integrally formed as a one-piece structure rather than an assembled structure, and the switch 71b is a membrane switch and is disposed on the circuit board 70 corresponding to the connection member 41b.

Alternatively, as shown in FIG. 14, the difference between this embodiment and the first embodiment/the second embodiments lies in that, in this embodiment, the switch triggering member 40c only comprises a connection member 41c, the connection member 41c and the button 30 are integrally formed as a one-piece structure rather than an assembled structure, and the switch 71c is a button switch and is disposed on the circuit board 70 corresponding to the connection member 41c.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A button module of a game control device, wherein the button module comprises:
a hollow base having a top portion and a bottom portion;
a hollow adjustment member rotatably disposed on the top portion of the hollow base, wherein the hollow adjustment member has a top surface; and
a button disposed in the hollow adjustment member, wherein the button has a top end and a bottom end, the top end protrudes from the top surface of the hollow adjustment member, and the bottom end is connected to a switch triggering member;
wherein the hollow adjustment member is selectively rotated with respect to the hollow base to drive the button to be moved to a first height position or a second height position; when the button is at the first height position, a first spacing is between the switch triggering member and the bottom portion of the hollow base, when the button is at the second height position, a second spacing is between the switch triggering member and the bottom portion of the hollow base, and the second spacing is different from the first spacing.

2. The button module of the game control device according to claim 1, further comprising an elastic member, wherein the elastic member is disposed in the hollow base and elastically abuts against the button.

3. The button module of the game control device according to claim 1, wherein the top surface of the hollow adjustment member has a skidproof structure.

4. The button module of the game control device according to claim 3, wherein the skidproof structure comprises at least one selected from the group consisting of at least one concave portion and at least one convex portion.

5. The button module of the game control device according to claim 1, wherein the hollow base has an inner annular surface, and the inner annular surface has a first thread portion; the hollow adjustment member has an outer annular surface, the outer annular surface has a second thread portion, and the second thread portion is threaded with the first thread portion.

6. The button module of the game control device according to claim 1, wherein the hollow adjustment member has a bottom surface, the button has a hook portion, and the hook portion is hooked at the bottom surface.

7. The button module of the game control device according to claim 6, wherein the bottom surface has a first supporting surface and a second supporting surface at different heights; when the button is at the first height position, the hook portion is hooked at the first supporting surface, and when the button is at the second height position, the hook portion is hooked at the second supporting surface.

8. The button module of the game control device according to claim 7, wherein the bottom surface has a guiding bevel, and the guiding bevel is connected between the first supporting surface and the second supporting surface.

9. The button module of the game control device according to claim 1, wherein the hollow adjustment member has an outer annular surface, the outer annular surface has a plurality of limiting grooves, and the limiting grooves are arranged annularly and spaced apart from each other; the hollow base is provided with an elastic piece, and the elastic piece has a limiting protrusion; when the button is at the first height position, the limiting protrusion is limited within one of the limiting grooves, and when the button is at the second height position, the limiting protrusion is limited within another one of the limiting grooves.

10. The button module of the game control device according to claim 1, wherein the hollow adjustment member has an outer annular surface, the outer annular surface has a plurality of grooves, and the grooves are arranged annularly and spaced apart from each other; the hollow base has a flexible arm, and the flexible arm has a protrusion; when the button is at the first height position, the protrusion is limited within one of the grooves, and when the button is at the second height position, the protrusion is limited within another one of the grooves.

11. The button module of the game control device according to claim 1, wherein the hollow adjustment member has an outer annular surface, and the outer annular surface is provided with a limiting flange.

12. The button module of the game control device according to claim 1, wherein when the hollow adjustment member is rotated with respect to the hollow base, the hollow adjustment member is moved to different height positions with respect to the bottom portion of the hollow base.

13. The button module of the game control device according to claim 1, wherein when the hollow adjustment member is rotated with respect to the hollow base, a height position of the hollow adjustment member with respect to the bottom portion of the hollow base is not changed.

14. A game control device comprising:
a housing comprising a cover plate, wherein the cover plate has an outer surface and a through hole;
a circuit board disposed in the housing, wherein the circuit board has a switch; and
a button module according to claim 1, wherein the button module is disposed in the housing and corresponds to the through hole, the top end of the button of the button module protrudes from the outer surface of the cover plate, and a position of the switch triggering member corresponds to a position of the switch.
